(19) United States
(12) Patent Application Publication
(10) Pub. No.: US 2002/0069168 A1
(43) Pub. Date: Jun. 6, 2002

(54) System and method for performing personal finance management using the internet

(75) Inventors: KangYoon Lee, Koyang (KR); HongGyu Lee, KyeongKi-Do (KR)

Correspondence Address: Robert P. Tassinari, Jr., Intellectual Property Law Dept., IBM Corporation, P.O. Box 218, Yorktown Heights, NY, 10598, US

(73) Assignee: International Business Machines Corporation, Armonk, NY

(21) Appl. No.: 10/053,303

(22) Filed: Nov. 7, 2001

(30) Foreign Application Priority Data
Nov. 23, 2000 (KR) 2000-0069781

(51) Int. Cl. G06F 17/60

(52) U.S. Cl. 705/40; 705/42

(57) ABSTRACT

The Personal Finance Management (PFM) system of the present invention can be connected to a bank server and a plurality of electronic bill presentation and payment (“EBPP”) servers via the Internet and obtain a user's bank account information data from the bank server and billing information data from the EBPP servers. The PFM system can present a user with a payment schedule based on the bank account information and the billing information so that the user can manage his/her finance matters efficiently. Furthermore, the PFM system can enable the user to determine when and how to pay the bill.

The PFM system of the present invention, which can be connected to a bank server and a plurality of EBPP servers over the Internet, comprises means for obtaining the user's bank account information data from a bank server; means for collecting billing information data from each of the EBPP servers, said billing information data including an amount to be paid and payment due date; means for presenting a payment schedule based on said bank account information data and said billing information data; and means for enabling the user to select how and when to pay the bills and forwarding said user's selection on the payment to the bank server.

### BACKGROUND OF THE INVENTION

1. Technical Field

The present invention relates to a system and method for performing personal finance management using the internet, and in particular to a system and method for performing personal finance management by obtaining a user's bank account information and user's billing information from a bank server and a plurality of Electronic Bill Presentation and Payment (hereinafter, “EBPP”) servers, respectively, via the internet and providing the obtained information to the user.

2. Description of Related Art

Traditionally, billers including merchant, government, and intermediate billing services such as credit card companies have sent billing information to users via air mails. These days, with the increasing popularity of the Internet and e-mail service, the billers have their own EBPP servers that can create the user's billing information, store them, and run a web site where the user can check his/her billing information. In addition, some EBPP servers can distribute user's billing information via e-mail, if the user wants to do so.

However, the conventional billing service using e-mail has drawbacks. The user may have difficulty in integrally managing many pieces of billing information, each of them being included in separate e-mails, and figuring out payment plan based on them.

Furthermore, with respect to bills to be paid regularly, such as a credit card bill, a telephone charge bill, apartment management bill, etc., users usually apply for “automatic (reserved) transfer service” at a bank. The automatic (reserved) transfer service causes a certain amount to be automatically transferred from the user's designated bank account to the biller's account at a designated payment date of every month. However, in the case that a balance is not enough in the user's bank account, the user must change a bill payment method or a payment date. In this case, the user must directly call the billing company and request such change.

In light of the foregoing, it is desirable to provide an improved personal finance management system and method that enables a user to effectively manage many pieces of billing information directly received from the billers (physically, from their EBPP servers) and figure out a payment plan based on the current balance in his/her bank account.

### SUMMARY OF THE INVENTION

Accordingly, it is an object of the present invention to provide a system and method for performing personal finance management by collecting a user's billing information from more than one EBPP server through the Internet and presenting a payment schedule based on the collected billing information to the user.

It is another object of the present invention to provide a system and method for performing personal finance management by collecting a user's billing information and bank account information received from more than one EBPP server and a bank server, respectively, and, in view of the collected billing information and bank account information, computing an estimated balance on payment due date assuming that the amount due is transferred from the user's bank account to the biller's account at that date, so that the user can predict his/her finance condition.

It is another object of the present invention to provide a system and method for performing personal finance management that can provide a user with billing information and bank account information collected from more than one EBPP server and a designated bank server through the Internet and enable the user to determine how and when to pay the bills.

To achieve the above objects, according to one aspect of the present invention, there is provided a personal finance management (“PFM”) system connected to a bank server and a plurality of EBPP servers over the internet. The system comprises means for obtaining a user's bank account information data from the bank server; means for collecting billing information data from each of the EBPP servers, said billing information data including an amount to be paid and payment due date; means for presenting a payment schedule based on said bank account information data and said billing information data; and means for enabling the user to select how and when to pay the bills and forwarding said user's selection on the payment to the bank server. The user's selection on the payment can be an immediate account transfer, a reserved account transfer, an automatic account transfer or transfer cancellation of the amount to be paid, from the user's account. The system of the present invention further comprises means for calculating and presenting an estimated balance on payment due date, in advance, assuming that said amount to be paid is transferred from the user's bank account on the payment due date. In addition, the system further comprises means for alarming the user when the estimated balance is negative. Accordingly, the user learns that the balance in the bank account is not enough to pay the bills, so the user can delay the payment date or change the payment method. Other features of the present invention will be apparent from the accompanying drawings and from the detailed description that follows.

### BRIEF DESCRIPTION OF THE DRAWINGS

The novel features believed characteristic of the invention are set forth in the appended claims. The invention, itself, however, as well as a preferred mode of use, further objectives and advantages thereof, will best be understood by reference to the following detailed description of an illustrative embodiment when read in conjunction with the accompanying drawings, wherein:

FIG. 1 shows a network environment in which the PFM system may be implemented in accordance with a preferred embodiment of the present invention;

FIG. 2 is a configuration diagram of the PFM system in accordance with the preferred embodiment of the present invention;

FIG. 3 is an input screen example for entering EBPP server connection-related information in a PFM system in accordance with the preferred embodiment of the present invention;

FIG. 4 is a flowchart illustrating a PFM process system in accordance with the preferred embodiment of the present invention;

FIG. 5 is an example of a screen which shows a monthly payment schedule in the PFM system in accordance with the preferred embodiment of the present invention; and

FIG. 6 is an example of a screen which shows a daily payment schedule provided in the PFM system in accordance with the preferred embodiment of the present invention.

### DETAILED DESCRIPTION OF THE PREFERRED EMBODIMENTS

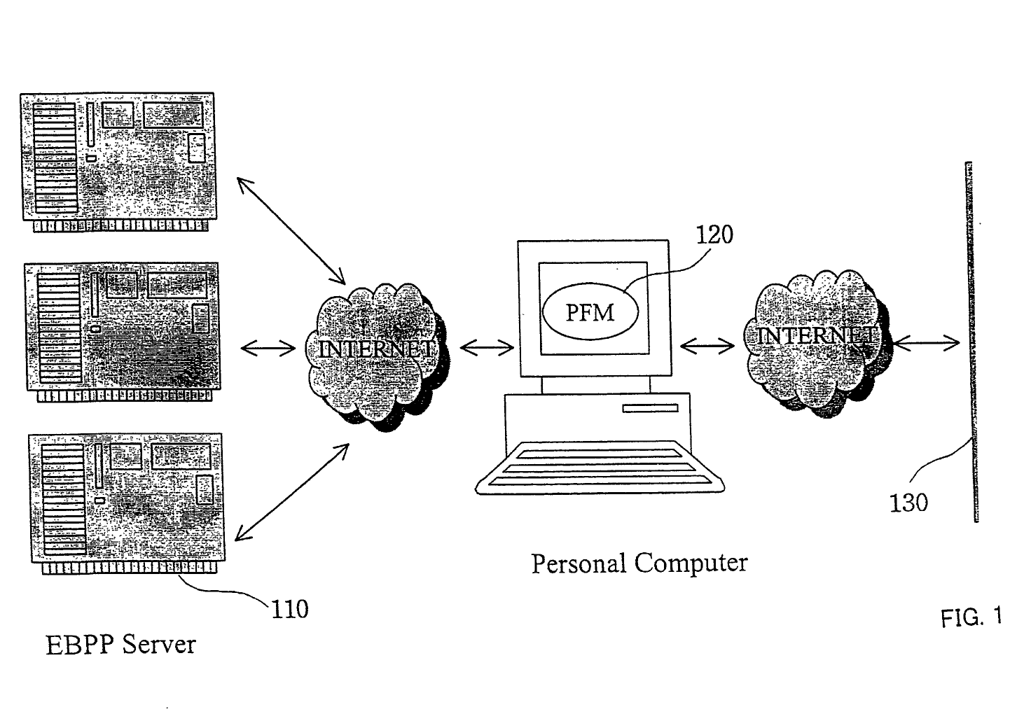

With reference now to the figures and in particular with reference to FIG. 1, a network environment in which the PFM system may be implemented in accordance with a preferred embodiment of the present invention is depicted. As shown in FIG. 1, a personal computer (PC), in which a PFM system 120 can be implemented, may be connected with a plurality of EBPP servers 110 and a bank server 130 over the Internet. Although the depicted computer in which the PFM system 120 will be implemented is a PC, other embodiments of the present invention may be implemented in other types of data processing systems, such as small hand-held/portable computers with Internet capabilities.

Generally, the EBPP servers 110 may be operated by billing companies (for example, telephone service companies, insurance companies, credit card companies, etc.) to create and present electrical billing information to users over communication networks such as the Internet. Each of the EBPP servers 110 includes a database for storing a user's billing information. It can distribute billing information to users by e-mail or provide a web site where users can visit and preview their billing information. In particular, the EBPP servers 110, which will be connected with the PFM system of the present invention, shall have a function of transmitting the billing information, in a predetermined format, in response to a request from the user's PFM system 120. A billing information format transmitted from the EBPP servers 110 to the PFM system 120 may be decided upon the mutual agreement between the billing companies operating the EBPP servers 110 and the bank providing the PFM service to users.

The PFM system 120 is a kind of a client program comprising a number of applets. The PFM system 120 can be connected with EBPP servers 110 and a bank server 130 over the Internet using a predetermined communication protocol such as HTTP protocol. Recently, many banks provide Internet banking service that enables a user to perform banking operations with respect to the user's bank account via the Internet without visiting the bank. The PFM system 120 may be a kind of the Internet banking service application program provided by banks.

However, the PFM system 120 in accordance with the present invention can be distinguished from the conventional Internet banking service program in that the PFM system 120 can directly collect billing information from a plurality of EBPP servers as well as obtain a user's bank account information from a bank server over the Internet. This method may be referred as a “pull mode” because the PFM system can directly obtain billing information from the EBPP servers whenever necessary, while the conventional method that the EBPP servers periodically send billing information to users is referred as “push mode.”

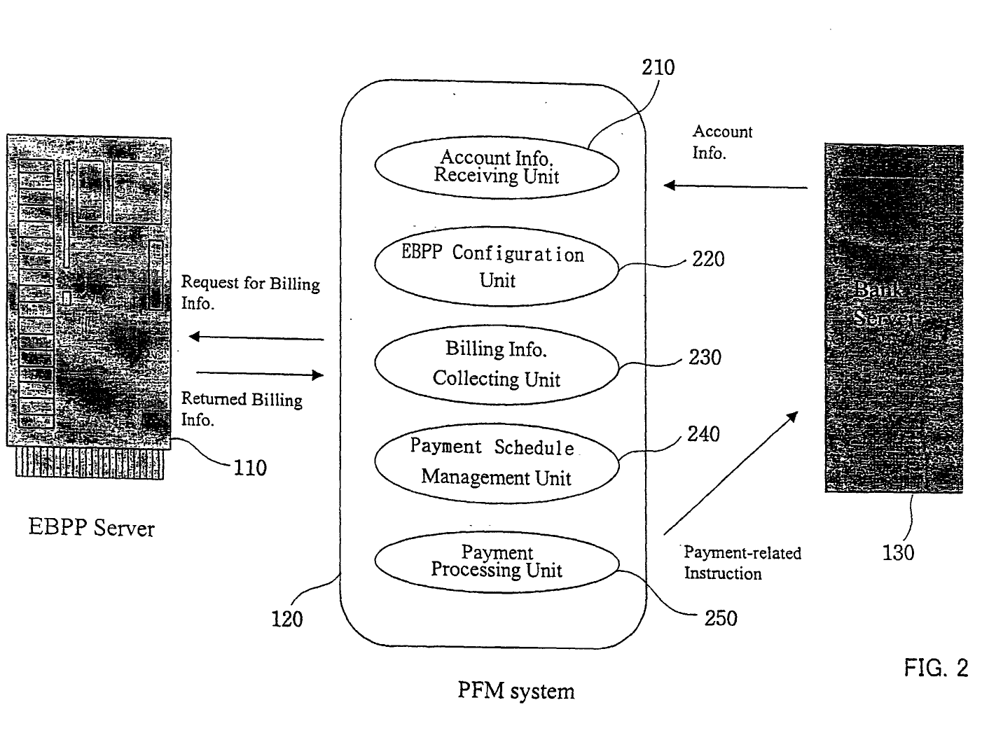

The PFM system 120 may calculate an estimated balance on payment due date, in advance, based on the billing information and bank account information obtained from the EBPP servers 110 and the bank server 130, and present it to the user, so that the user can predict his/her financial condition. The detailed construction of the PFM system 120 will be explained with reference to FIGS. 2-6.

The bank server 130 includes a database (not shown) for storing detailed information with respect to a user's bank accounts. The bank server 130 retrieves a user's bank account information from the database; transmits it to the PFM system of the user 120; and processes actual transfer transactions in response to payment (transfer) related instructions received from the PFM system 120. In addition, the bank server 130 may return the transaction result to the PFM system 120.

FIG. 2 is a configuration diagram of the PFM system in accordance with the preferred embodiment of the present invention. While there is shown one EBPP server for the purpose of simplicity, it can be easily understood by one of ordinary skill in the art that the PFM system of the present invention may be connected with a plurality of EBPP servers provided by various companies such as credit card companies, telephone service companies, etc.

An account information-receiving unit 210 receives more than one bank account information related to a user from the bank server 130. The received bank account information is stored into a certain local storage (for example, RAM or hard disk) in the system 120 for presentation to the user in a desirable display format. The bank account information may include banking transaction history details and current balance with respect to each of the user's bank accounts. In addition, if the user has borrowed money from the bank, the account information may include an amount of loan, repayment due date, loan interest and interest payment date, etc. In one embodiment of the present invention, the user can define the time period when the PFM system 120 is connected with the bank server 130 to receive bank account information. According to the user's setting information, the PFM system can be connected to the bank server when the PFM system initiates or can access the bank server at a certain time period.

EBPP configuration unit 220 manages and stores EBPP connection-related information related to the EBPP servers which the user has selected for collecting billing information using the PFM system 120. The EBPP connection-related information may include web site addresses (URLs) of the EBPP servers and user identification information associated with each of the EBPP servers, which is necessary for the EBPP servers to identify the user. For example, in order to receive a user's billing information from the EBPP server of the credit card company, the web site address of the EBPP server (for example, “www.abccard.co.kr”), user's ID and password, which may have been previously registered in that EBPP server, and a card number may be required.

According to the preferred embodiment of the present invention, at first, the EBPP configuration unit 220 provides the user with the list of available EBPP servers that allow the user to collect his/her billing information therefrom using the PFM system. Such list may be transmitted from the bank server into the PFM system for the user's selection. The user selects at least one EBPP server among the list and enters user's identification information with respect to the corresponding EBPP server. Usually, banks which provide the user with the PFM system have business relationship with the billing companies operating EBPP servers, in order to support the above billing information collection service.

A billing information collecting unit 230 connects to more than one EBPP server 110 based on the EBPP connection-related information, collects billing information related with the user, and then stores the collected billing information into a local storage of the PFM system 110. In order to request the user's billing information from the EBPP server 110, the billing information collecting unit 230 transfers the user's identification information to the EBPP server 110. The billing information, including an amount to be paid and payment due date, is received from the EBPP server 110 in a given format. A user may define a time period when the billing information collecting unit 230 will access the EBPP server 110 to collect the billing information.

A payment schedule management unit 240 presents a payment schedule in a user-friendly format to the user, based on the bank account information received from the bank server 130 and the billing information received from the EBPP server 110. In one embodiment according to the present invention, the payment schedule management unit 240 may also manage other information such as personal schedule, which may be entered by the user. In addition, the payment schedule management unit 240 can calculate an estimated balance in the account on payment due date based on the account information and billing information, in advance, assuming that an amount on the bill is transferred (or paid) from the user's account to the biller's account. Therefore, it is possible for the user to properly predict his/her financial condition. Furthermore, the payment schedule management unit 240 has a function of alerting a user, for example, using a pop-up window, when the calculated estimated balance is negative. The payment schedule management unit 240 may present the user's payment schedule on a daily, weekly and/or monthly basis. Also, it may have the additional function of analyzing billing information in terms of billing items and providing the user's consumption pattern ratio graphic chart and consumption tendency variation chart in various forms in view of the collected billing information.

The payment-processing unit 250 receives payment-related instruction on each bill to be paid, from the user, and forwards it to the bank server for actual transaction. Payment-related instructions may include transfer (or payment) method and payment (or transfer) date. Transfer method may include an immediate transfer that causes an amount to be paid to be immediately transferred from the designated user's account to the biller's account; a reserved transfer that causes an amount to be paid to be transferred at a reserved date; and an automatic (reserved) transfer that causes an amount to be paid to be transferred at a reserved date of every month. A user can choose the appropriate transfer method and payment date, considering his/her payment schedule. If the calculated estimated balance is supposed to be negative on the reserved date, the user can cancel the transfer. The payment-processing unit 250 forwards payment-related instructions to the bank server 130 for actual transfer transactions. It also provides the user with the transaction result returned from the bank server, also 130.

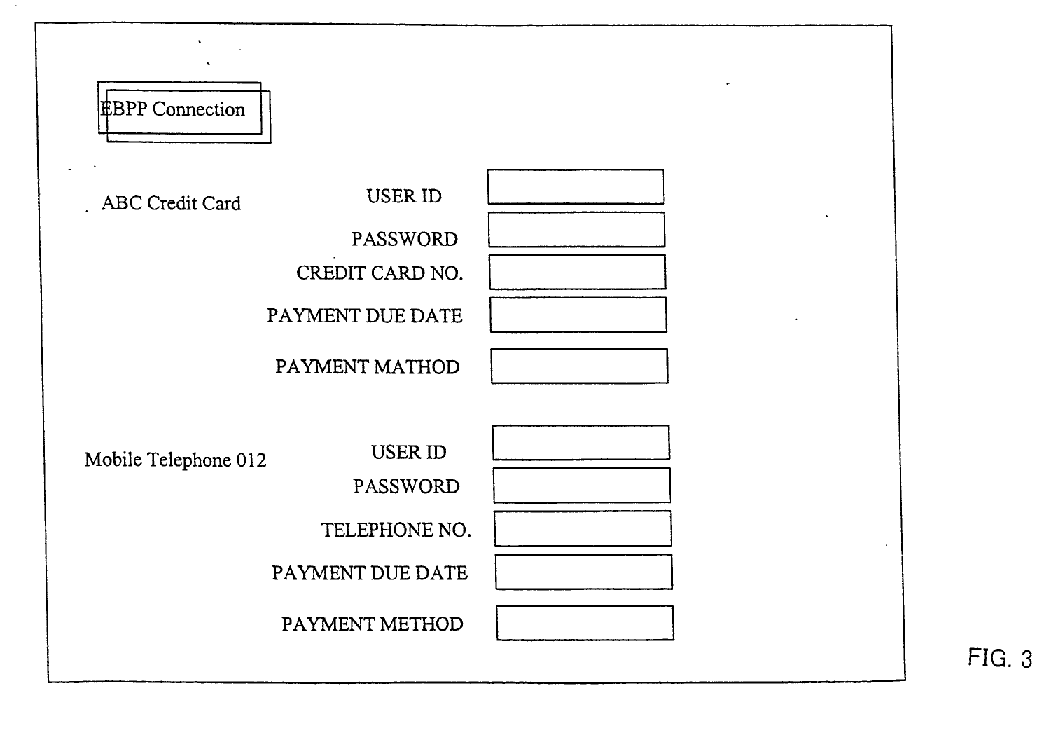

FIG. 3 is an input screen example for entering EBPP server connection-related information in the PFM system in accordance with the preferred embodiment of the present invention. As shown in FIG. 3, there are blanks for entering so-called EBPP server connection-related information including a user's ID and password as well as a user's credit card number (in the case of the EBPP of a credit card company) or telephone number (in the case of the EBPP of a telephone company). Please note that such information is pre-registered information in the corresponding EBPP servers by users. In order to collect the user's billing information from various EBPP servers, the PFM system should store the EBPP server connection-related information for each of the EBPP servers in the local memory and send it to the corresponding EBPP server whenever connecting to the EBPP servers over the Internet. In addition, there may be other blanks for inputting payment date and payment method by users, so that the user may initially set them at his/her convenience. However, certain kinds of bills have fixed payment date so that the user cannot freely change the payment date. The payment date and payment method set by the user may be displayed in a payment schedule, which will be explained later. Please note that the input items related to the EBPP server connection-related information are just illustrative for simple explanation.

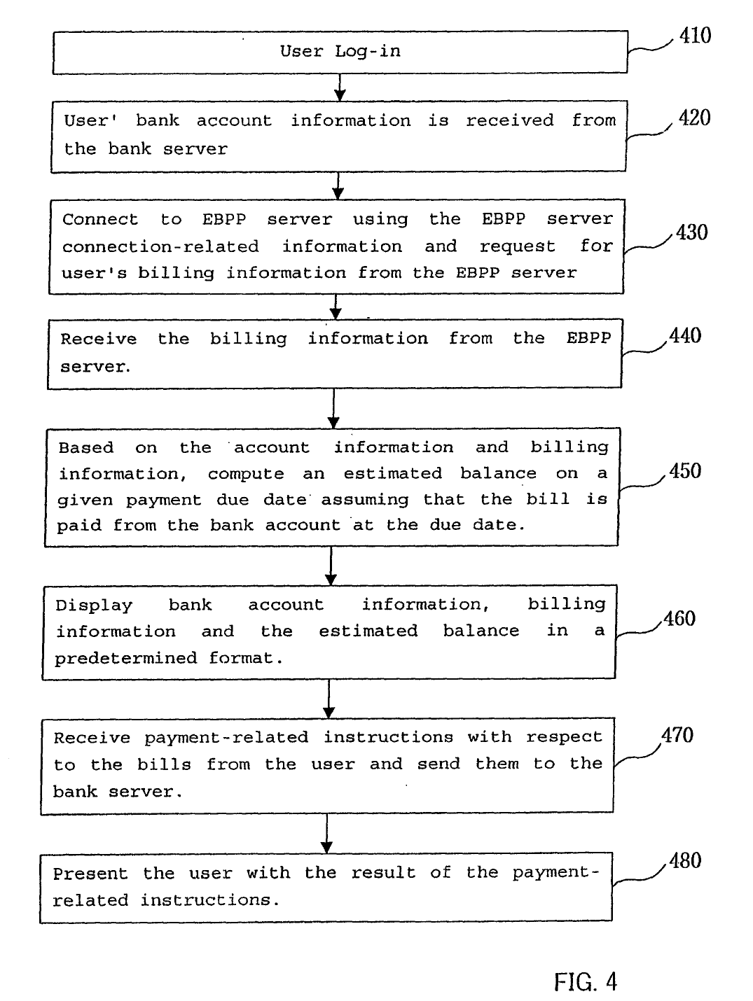

FIG. 4 is a flow chart illustrating a PFM process in accordance with the preferred embodiment of the present invention. At step 410, the PFM system connects with the bank server and then performs a user authentication procedure. In one embodiment, the user enters the user ID and password, which the user has already registered in the bank server during the user registration procedure with respect to the use of a PFM system. At step 420, the user's more than one bank account information is received from the bank server. The account information may include account transaction details and the current balance therein. Also, in case of a loan account, an amount of loan interest to be paid and its payment date may be included in the account information. In addition, other information such as an advertisement or notice information may be received from the bank to the user.

At step 430, the PFM system is connected with more than one EBPP server using the EBPP server connection-related information, which has been previously stored in the local memory of the PFM system, and requests the user's billing information from the EBPP servers. In a preferred embodiment of the present invention, the PFM system can be connected with the EBPP servers by performing a “CALL” instruction for calling the URL address of the EBPP web site. When connecting to the EBPP server, the user identification information needed for the user's identification is transmitted to the EBPP server.

At step 440, the billing information including the bill details and payment due date is obtained from the EBPP server. While the above process has shown that the PFM system is connected to the EBPP server after the user initiates a login procedure, the present invention is not limited thereto. In another embodiment of the present invention, the PFM system may be connected to the EBPP server at a predetermined time period, irrespective of the user's login, thereby receiving the billing information periodically.

At step 450, based on the bank account information from the bank server and billing information from the EBPP server, an estimated balance relating to the bank account on a given payment due date is calculated, assuming that the amount to be paid is transferred from the bank account on that date. At step 460, the bank account information, billing information and the calculated estimated balance information are presented to the user in a desired format. Furthermore, according to the preferred embodiment of the invention, if the value of the estimated balance is negative, the PFM system can give the user an alarm notice.

At step 470, payment-related instruction with respect to the bill to be paid is received from the user and then forwarded to the bank server for an actual transfer transaction. The payment-related instruction may include transfer execution, change of transfer method and payment date, and transfer cancellation. The transfer method may include an immediate transfer, a reserved transfer and/or an automatic transfer. The user may request an immediate transfer (namely, payment execution) with respect to the bill. Otherwise, if the value of the estimated balance, which has been previously calculated at step 450, is shown to be negative, the user can change or cancel the predetermined transfer such as reserved transfer or automatic (reserved) transfer. The bank server then performs proper transaction according to the payment-related instruction from the PFM system and sends the result back to the PFM system.

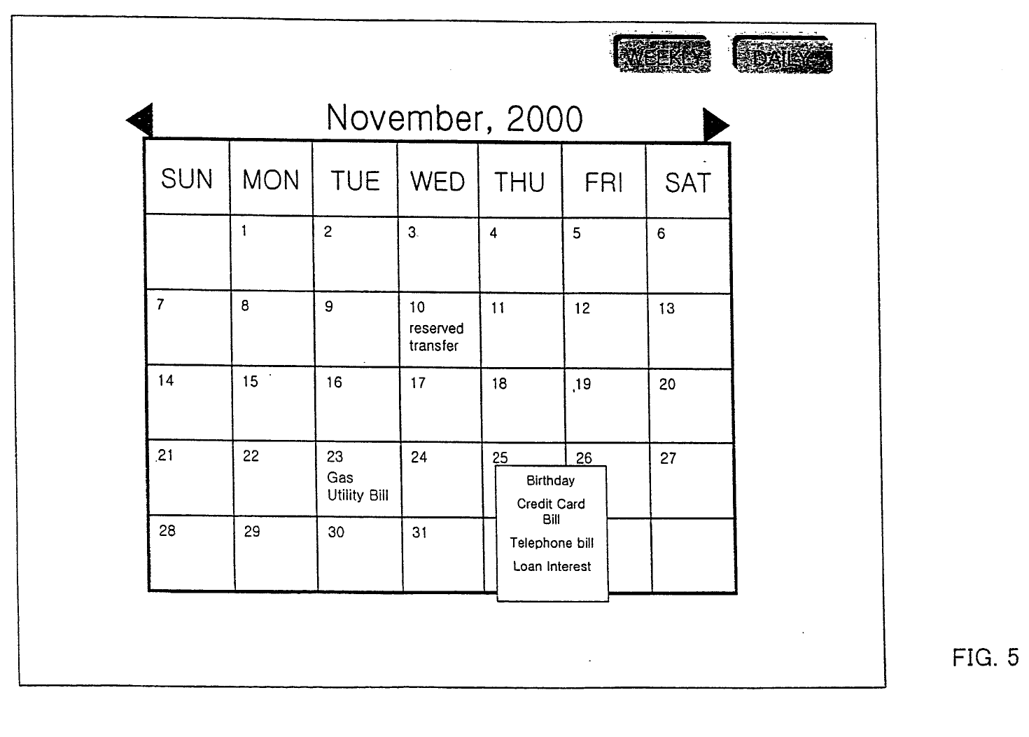

FIG. 5 is an-example of a screen, which shows a monthly payment schedule in the PFM system in accordance with the preferred embodiment of the present invention. The schedule related to the billing information and the information related to a user's other schedules are shown in a calendar form. Namely, as shown in FIG. 5, a billing information such as a credit card bill, a loan repayment bill, a gas utility bill, etc., and a user's personal schedule (for example, someone's birthday) may be displayed on the calendar. The personal schedule may be entered into the PFM system by the user. The system then stores the personal schedule information at a local memory and displays it on the calendar. When the user clicks a weekly menu or a daily menu, which are shown on the left upper portion of the screen, the weekly or daily payment schedule may be displayed.

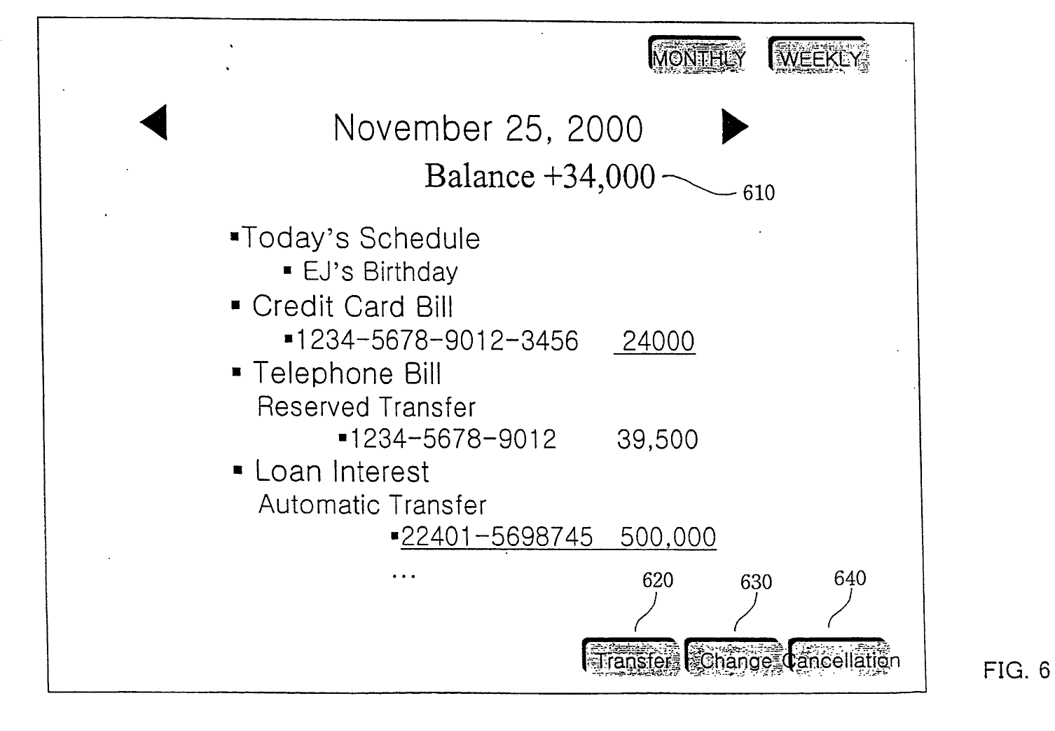

FIG. 6 is an example of a screen which shows a daily payment schedule in the PFM system in accordance with the preferred embodiment of the present invention. There is shown the detailed information regarding the user's given bank account status on Nov. 25, 2000. The detailed information includes a personal schedule as well as three kinds of billing information including bill contents, the corresponding amounts to be paid and payment method. As shown in FIG. 6, telephone charge (24000 won), credit card charge (39500 won) and loan interest (500000 won), all of which are to be paid by November 25, are displayed on the screen. In addition, assuming that all three payments are paid on November 25, an estimated balance of “+34000” 610, which will remain after the payment, is displayed. While the above screen represents the information relating to only one bank account, it is possible to show the information regarding two more bank accounts, if needed.

After the user checks the estimated balance, the user can change the transfer method with respect to each of the bills. The icons of “Transfer (or payment) Execution” 620, “Transfer Change” 630 and “Transfer Cancellation” 640 are shown on the lower portion of the screen. The user can change payment method by clicking the icon of “Transfer Change” 630 or cancel payment by clicking the icon of “Transfer Cancellation.”

As described above, according to the PFM system of the present invention, the user can check a plurality of bill information on a daily basis without visiting the web site of the EBPP server, so that it is possible to effectively manage the billing schedule. In addition, the PFM system allows a user to predict the lack of balance for future payment and change payment method (namely, transfer method) so that the user can avoid any inappropriate payment and dynamically manage his/her finances.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A system for performing personal finance management using the Internet, the system being connected to a bank server and a plurality of electronic bill presentation and payment (“EBPP”) servers over the Internet, comprising:
means for obtaining a user's bank account information data from the bank server;
means for collecting billing information data from each of the EBPP servers, said billing information data including an amount to be paid and payment due date;
means for presenting a payment-schedule based on said bank account information data and said billing information data; and
means for enabling the user to select how and when to pay the bills and forwarding said user's selection on the payment to the bank server.

2. The system of claim 1, wherein said user's selection on the payment can be an immediate account transfer, a reserved account transfer, an automatic account transfer or transfer cancellation of the amount to be paid, from the user's bank account.

3. The system of claim 1, further comprising means for calculating and presenting an estimated account balance on the payment due date, in advance, assuming that said amount to be paid is transferred from the user's bank account on the payment due date.

4. The system of claim 1, wherein the payment-schedule can be displayed on a daily-basis, weekly-basis or monthly-basis.

5. The system of claim 1, further comprising means for presenting the payment result received from the bank server to the user.

6. The system of claim 1, said means for collecting billing information data comprising:
means for storing user identification information data for each of the EBPP servers;
means for requesting billing information data to each of the EBPP servers using said stored user identification information; and
means for storing the billing information received from the each of the EBPP servers.

7. The system of claim 3, further comprising means for alerting the user when said estimated account balance is less than zero.

8. A method for performing personal finance management using the Internet, comprising the following steps of:
obtaining a user's bank account information data from a bank server;
collecting billing information data from each of a plurality of EBPP servers, said billing information data including an amount to be paid and payment due date;
presenting a payment-schedule based on said bank account information data and said billing information data; and
enabling the user to select how and when to pay the bills and forwarding said user's selection on the payment to the bank server.

9. The method of claim 8, wherein said user's selection on the payment can be an immediate account transfer, a reserved account transfer, an automatic account transfer or transfer cancellation of the amount to be paid, from the user's bank account.

10. The method of claim 8, further comprising the step of calculating and presenting an estimated account balance on the payment due date, in advance, assuming that said amount to be paid is transferred from the user's bank account on the payment due date.

11. The method of claim 8, further comprising the step of presenting the payment result received from the bank server to the user.

12. The method of claim 8, wherein the payment-schedule can be displayed on a daily-basis, weekly-basis or monthly-basis.

13. The method of claim 8, said step of collecting billing information data, comprising the following steps of:
storing user identification information data for each of the EBPP servers;
requesting billing information data to each of the EBPP servers using said stored user identification information; and
storing the billing information received from the each of the EBPP servers.

14. The method of claim 10, further comprising the step of alerting the user when said estimated account balance is less than zero.

15. A computer-program product in a computer readable medium for use in a data processing system for performing finance management using the Internet, the computer program product comprising the program instructions for:
obtaining a user's bank account information data from a bank server;
collecting billing information data from each of a plurality of EBPP servers, said billing information data including an amount to be paid and payment due date;
presenting a payment-schedule based on said bank account information data and said billing information data; and
enabling the user to select how and when to pay the bills and forwarding said user's selection on the payment to the bank server.

16. The computer program product of claim 15, wherein said user's selection on the payment can be an immediate account transfer, a reserved account transfer, an automatic account transfer or transfer cancellation of the amount to be paid, from the user's bank account.

17. The computer program product of claim 15, further comprising the program instructions for calculating and presenting an estimated account balance on the payment due date, in advance, assuming that said amount to be paid is transferred from the user's bank account on the payment due date.

18. The computer program product of claim 15, further comprising the program instructions for presenting the payment result received from the bank server to the user.

19. The computer program product of claim 15, wherein the payment-schedule can be displayed on a daily-basis, weekly basis or monthly basis.

20. The computer program product of claim 15, said program instructions for collecting billing information data, comprising the following subinstructions for:
storing user identification information data for each of the EBPP servers;
requesting billing information data to each of the EBPP servers using said stored user identification information; and
storing the billing information received from the each of the EBPP servers.

21. The computer program product of claim 17, further comprising the program instructions for alerting the user when said estimated account balance is less than zero.
